(19) United States
(12) Patent Application Publication
(10) Pub. No.: US 2024/0364489 A1
(43) Pub. Date: Oct. 31, 2024

(54) METHOD AND APPARATUS FOR IN-BAND MULTI-CHANNEL DETERMINATION AND UTILIZATION

(71) Applicant: EDGEWATER WIRELESS SYSTEMS INC., Kanata (CA)

(72) Inventor: Eric Scott SMITH, Lafayette, CO (US)

(21) Appl. No.: 18/643,333

(22) Filed: Apr. 23, 2024

Related U.S. Application Data
(60) Provisional application No. 63/461,709, filed on Apr. 25, 2023.

(51) Int. Cl. H04L 5/00; H04W 28/02; H04W 48/06; H04W 72/0453; H04W 72/54

(52) U.S. Cl. CPC H04L 5/0098; H04L 5/0073; H04W 28/0252; H04W 48/06; H04W 72/0453; H04W 72/54

(57) ABSTRACT

A method and apparatus for managing communications in a wireless communication system such as a WiFi system, at an access point, are provided. Various measurements such as number of devices connected to the access point and using a wireless channel, number of devices not connected to the access point but contending for a wireless channel, proportion of time a wireless channel is in use, transmission quality of a wireless channel, interference due to wireless activity according to a process other than the protocol of the communication system, and interference due to wireless activity according to a different process, are made. Based on the measurements, decisions of how to partition a portion of spectrum into a number of channels as well as the number of channels, or decisions of whether to enable or disable such channels or portions of spectrum, are made.

### CROSS-REFERENCE TO RELATED APPLICATIONS

This application claims the benefit and priority of U.S. Provisional Application No. 63/461,709 filed Apr. 25, 2023. The foregoing application is incorporated by reference herein in its entirety.

### FIELD OF THE INVENTION

The invention relates generally to telecommunications and, more particularly, to methods and apparatus for in-band multi-channel determination and utilization for wireless communications systems such as IEEE 802.11 systems.

### BACKGROUND

Wireless communications involve the use of shared wireless communication channels, which are subject to degradation due to channel contention, noise, interference, etc. It is desirable to discover and implement strategies which provide for high-quality communications even when such degradations are present. This situation is present particularly in IEEE 802.11 and similar communications systems which utilize unlicensed portions of wireless spectrum for communication.

A range of wireless frequencies can be separated into multiple channels, so that each channel occupies a different subset of those frequencies. This is one approach by which wireless spectral resources can be shared in order to mitigate channel degradations. However, there are a large number of possible channelization strategies. This leaves open the opportunity for discovering effective instances of such strategies. Furthermore, static channelization strategies are not optimal since they do not account for the particulars of a dynamic wireless environment. The current state of the art is subject to improvement in a variety of ways, to more effectively make use of wireless spectrum.

Therefore, there is a need for methods, apparatus and systems that are not subject to one or more limitations of the prior art.

### SUMMARY OF THE INVENTION

According to a first broad aspect, the invention seeks to provide a method of managing bandwidth in a network. The method comprises: receiving first values of primary decision variables of one, two or more channels of a communications band of the network; evaluating the first values against first thresholds of the first values and configuring a bandwidth of the channels of the communications band based on evaluation of the first values; receiving second values of secondary decision variables of the channels of the communications band; evaluating the second values against second thresholds of the second values and configuring a number of the channels of the communications band based on evaluation of the second values; receiving third values of tertiary decision variables of the communications band; and evaluating the third values against third thresholds of the third values and configuring a spectrum of the communications band based on evaluation of the third values.

According to a second broad aspect, the invention seeks to provide a method of managing bandwidth in a network. The method comprises: receiving first values of primary decision variables of one, two or more channels in a communications band of the network, the primary decision variables comprising a number of connected devices and a number of unconnected devices contending for the bandwidth of the channels of the communications band; evaluating the first values against first thresholds of the first values; and configuring a quantity of the channels and bandwidth of the channels within the communications band based on evaluation of the first values.

According to a third broad aspect, the invention seeks to provide an apparatus for managing bandwidth in a network. The apparatus comprises: a computing apparatus operable to receive first values of primary decision variables of one, two or more channels in a communications band of the network, the primary decision variables comprising a number of connected devices and a number of unconnected devices contending for the bandwidth of the channels of the communications band; to evaluate the first values against first thresholds of the first values; and to configure a quantity of the channels and bandwidth of the channels within the communications band based on evaluation of the first values.

According to another aspect there is provided a method for managing a communication band at an access point of a network. The communication band has a frequency bandwidth associated thereto and configured to have one or more channels. The communication band may be configured to operate by a protocol including an IEEE 802.11 WiFi standard. The one or more channels define a quantity of channels. The method includes obtaining, for at least one of the one or more channels, one or more respective channel configuration measures, all the one or more channel configuration measures defining a set of channel configuration measures. The method includes evaluating the set of channel configuration measures against one or more pre-determined configuration evaluation rules. The method includes, based on the evaluating the set of channel configuration measures against the one or more pre-determined configuration evaluation rules: determining the quantity of channels, and initiating partitioning of the frequency bandwidth among the quantity of channels.

In some embodiments, obtaining, evaluating, determining and initiating partitioning are performed repeatedly for responsiveness to changing communication conditions and channel configurations.

In some embodiments, the set of channel configuration measures includes at least one of: a number of connected devices communicating using the communication band; a number of contending unconnected devices communicating or attempting to communicate using the communication band; a respective value of a utilization metric for at least one of the one or more channels, the utilization metric indicative of a proportion of time that said at least one of the one or more channels is in use; and a respective value of a transmission quality metric for at least one of the one or more channels, the transmission quality metric indicative of an observed or expected quality of transmissions made using the at least one of the one or more channels.

In some embodiments, the set of channel configuration measures includes: a number of connected devices communicating using the communication band; and a number of contending unconnected devices communicating or attempting to communicate using the communication band.

In some embodiments, at least one of the one or more pre-determined configuration evaluation rules includes a respective threshold, and, for each of the at least one pre-determined configuration evaluation rules, the respective threshold is or involves at least one of: a maximum number of connected devices communicating using the communication band; a maximum number of contending unconnected devices communicating or attempting to communicate using the communication band; a maximum value of the utilization metric; and a maximum value of the transmission quality metric, where the transmission quality metric is a decreasing function of said observed or expected quality of transmissions.

In some embodiments, at least one of the one or more pre-determined configuration evaluation rules includes a respective threshold and, for each of the at least one pre-determined configuration evaluation rules, the respective threshold includes at least one of: a sum of a maximum number of connected devices communicating using the communication band and a maximum number of unconnected devices communicating or attempting to communicate using the communication band; and an average of the maximum number of connected devices and the maximum number of unconnected devices.

In some embodiments, evaluating the set of channel configuration measures against the one or more pre-determined configuration evaluation rules includes evaluating a combination of channel configuration measures of the set of channel configuration measures against a combination of pre-determined configuration evaluation rules of the one or more pre-determined configuration evaluation rules.

In some embodiments, at least one of the one or more pre-determined configuration evaluation rules includes a respective threshold, and, based on the evaluating the set of channel configuration measures against the one or more pre-determined configuration evaluation rules, determining the quantity of channels and initiating partitioning of the frequency bandwidth among the quantity of channels includes: when one of the set of channel configuration measures or a combination of channel configuration measures of the set of channel configuration measures exceeds the threshold of one of the one or more pre-determined configuration evaluation rules, initiating dividing at least one of the one or more channels into a plurality of narrower channels.

In some embodiments, each of the one or more channels is designated as either active or inactive; and the method further includes: obtaining, for at least one of the one or more channels, one or more respective channel activation measures, all the channel activation measures defining a set of channel activation measures; evaluating the set of channel activation measures against one or more pre-determined channel evaluation rules; and based on the evaluating the set of channel activation measures against the one or more pre-determined channel evaluation rules, at least one of: initiating activation of an inactive channel of the one or more channels, and initiating deactivation of an active channel of the one or more channels.

In some embodiments, the set of channel activation measures includes at least one of: a number of connected devices communicating using the communication band; a number of contending unconnected devices communicating or attempting to communicate using the communication band; a respective value of a utilization metric for at least one of the one or more channels, the utilization metric indicative of a proportion of time that said at least one of the one or more channels is in use; and a respective value of a transmission quality metric for at least one of the one or more channels, the transmission quality metric indicative of an observed or expected quality of transmissions made using the at least one of the one or more channels.

In some embodiments, the set of channel activation measures includes one or both of: a respective value of a utilization metric for at least one of the one or more channels, the utilization metric indicative of a proportion of time that said at least one of the one or more channels is in use; and a respective value of a transmission quality metric for at least one of the one or more channels, the transmission quality metric indicative of an observed or expected quality of transmissions made using the at least one of the one or more channels.

In some embodiments, at least one of the one or more pre-determined channel evaluation rules includes a respective threshold, and for each of the at least one pre-determined channel evaluation rules, the respective threshold is one of: a maximum number of connected devices communicating using the communication band; a maximum number of contending unconnected devices communicating or attempting to communicate using the communication band; a maximum value of the utilization metric; and a maximum value of the transmission quality metric, where the transmission quality metric is a decreasing function of said observed or expected quality of transmissions.

In some embodiments, evaluating the set of channel activation measures against one or more pre-determined channel evaluation rules includes evaluating a combination of channel activation measures of the set of channel activation measures against a combination of pre-determined channel evaluation rules of the one or more pre-determined channel evaluation rules.

In some embodiments, the method includes, for each of the one or more channels: obtaining one or more respective channel activation measures; and evaluating the one or more respective channel activation measures against the one or more pre-determined channel evaluation rules.

According to another aspect there is provided an apparatus comprising a processor and a transceiver and configured to manage a communication band. The communication band has a frequency bandwidth associated thereto and configured to have one or more channels, the one or more channels defining a quantity of channels. The apparatus is operative to obtain, for at least one of the one or more channels, one or more respective channel configuration measures, all the one or more channel configuration measures defining a set of channel configuration measures. The apparatus is operative to evaluate the set of channel configuration measures against one or more pre-determined configuration evaluation rules. The apparatus is operative, based on the evaluating the set of channel configuration measures against the one or more pre-determined configuration evaluation rules, to: determine the quantity of channels; and initiate partitioning of the frequency bandwidth among the quantity of channels.

The apparatus can further be configured to operate according to aspects and embodiments of the method as already described above.

According to another aspect there is provided a method for managing a communication band at an access point of a network. The communication band is configured to have a plurality of channels each being designated as either active or inactive. The communication band may be configured to operate by a protocol including an IEEE 802.11 WiFi standard. The method includes obtaining, for at least one of the plurality of channels, one or more respective channel activation measures, all the channel activation measures defining a set of channel activation measures. The method includes evaluating the set of channel activation measures against one or more pre-determined channel evaluation rules. The method includes, based on the evaluating the set of channel activation measures against the one or more pre-determined channel evaluation rules, at least one of: initiating activation of an inactive channel of the plurality of channels; and initiating deactivation of an active channel of the plurality of channels.

In some embodiments, obtaining, evaluating, initiating activation and initiating deactivation are performed repeatedly for responsiveness to changing communication conditions and channel configurations.

In some embodiments, the set of channel activation measures includes at least one of: a number of connected devices communicating using the communication band; a number of contending unconnected devices communicating or attempting to communicate using the communication band; a respective value of a utilization metric for at least one of the plurality of channels, the utilization metric indicative of a proportion of time that said at least one of the plurality of channels is in use; and a respective value of a transmission quality metric for at least one of the plurality of channels, the transmission quality metric indicative of an observed or expected quality of transmissions made using the at least one of the plurality of channels.

In some embodiments, the set of channel activation measures includes one or both of: a respective value of a utilization metric for at least one of the plurality of channels, the utilization metric indicative of a proportion of time that said at least one of the plurality of channels is in use; and a respective value of a transmission quality metric for at least one of the plurality of channels, the transmission quality metric indicative of an observed or expected quality of transmissions made using the at least one of the plurality of channels.

In some embodiments, at least one of the one or more pre-determined channel evaluation rules includes a respective threshold, and for each of the at least one pre-determined channel evaluation rules, the respective threshold is or involves at least one of: a maximum number of connected devices communicating using the communication band; a maximum number of contending unconnected devices communicating or attempting to communicate using the communication band; a maximum value of the utilization metric; and a maximum value of the transmission quality metric, where the transmission quality metric is a decreasing function of said observed or expected quality of transmissions.

In some embodiments, evaluating the set of channel activation measures against one or more pre-determined channel evaluation rules includes: evaluating a combination of channel activation measures of the set of channel activation measures against a combination of pre-determined channel evaluation rules of the one or more pre-determined channel evaluation rules.

In some embodiments, the method includes, for each of the plurality of channels: obtaining one or more respective channel activation measures; and evaluating the one or more respective channel activation measures against the one or more pre-determined channel evaluation rules.

In some embodiments, the communication band has associated thereto a frequency bandwidth including at least one of the plurality of channels. In some such embodiments, the method further comprises: obtaining one or more spectrum quality measures for the frequency bandwidth of the communication band; and evaluating the one or more spectrum quality measures against one or more pre-determined spectrum evaluation rules; and based on the evaluating the one or more spectrum quality measures against the one or more pre-determined spectrum evaluation rules, for one or more portions of the frequency bandwidth, at least one of: initiating collective activation of each inactive channel of the plurality of channels included in the one or more portions of the frequency bandwidth; and initiating collective deactivation of each active channel of the plurality of channels included in the one or more portions of the frequency bandwidth.

In some embodiments, the one or more spectrum quality measures include at least one of: an amount of a non-protocol-based interference metric indicative of wireless activity causing interference and generated according to a process other than a communication protocol used by the access point; and an amount of a of protocol-based interference metric indicative of wireless activity causing interference and generated according to the communication protocol used by the access point.

In some embodiments, at least one of the one or more pre-determined spectrum evaluation rules includes a respective threshold, and for each of the at least one pre-determined spectrum evaluation rules, the respective threshold is one of: a maximum amount of the non-protocol-based interference metric; and a maximum amount of the protocol-based interference metric.

In some embodiments, obtaining the one or more spectrum quality measures for the frequency bandwidth of the communication band includes: obtaining a respective one or more spectrum quality measures for each of the one or more portions of the frequency bandwidth of the communication band; and evaluating the one or more spectrum quality measures against the one or more pre-determined spectrum evaluation rules includes: evaluating, for each of the one or more portions of the frequency bandwidth of the communication band, the respective one or more spectrum quality measures against the one or more pre-determined spectrum evaluation rules.

According to another aspect there is provided an apparatus comprising a processor and a transceiver and configured to manage a communication band. The communication band is configured to have a plurality of channels each being either active or inactive. The apparatus is operative to obtain, for at least one of the plurality of channels, one or more respective channel activation measures, all the channel activation measures defining a set of channel activation measures. The apparatus is operative to evaluate the set of channel activation measures against one or more pre-determined channel evaluation rules. The apparatus is operative, based on the evaluating the set of channel activation measures against the one or more pre-determined channel evaluation rules, to perform at least one of: initiating activation of an inactive channel of the plurality of channels, and initiating deactivation of an active channel of the plurality of channels.

The apparatus can further be configured to operate according to aspects and embodiments of the method as already described above.

According to another aspect there is provided method for managing a communication band at an access point of a network. The communication band is configured to have one or more channels each being either active or inactive. The communication band has associated thereto a frequency bandwidth including the one or more channels. The communication band may be configured to operate by a protocol including an IEEE 802.11 WiFi standard. The method includes obtaining one or more spectrum quality measures for the frequency bandwidth of the communication band. The method includes evaluating the one or more spectrum quality measures against one or more pre-determined spectrum evaluation rules. The method includes, based on the evaluating the one or more spectrum quality measures against the one or more pre-determined spectrum evaluation rules, for one or more portions of the frequency bandwidth, at least one of: initiating collective activation of each inactive channel of the one or more channels included in the one or more portions of the frequency bandwidth; and initiating collective deactivation of each active channel of the one or more channels included in the one or more portions of the frequency bandwidth.

In some embodiments, obtaining, evaluating, initiating collective activation and initiating collective deactivation are performed repeatedly for responsiveness to changing communication conditions and channel configurations.

In some embodiments, the one or more spectrum quality measures include at least one of: an amount of a non-protocol-based interference metric indicative of wireless activity causing interference and generated according to a process other than a communication protocol used by the access point; and an amount of a protocol-based interference metric indicative of wireless activity causing interference and generated according to the communication protocol used by the access point.

In some embodiments, at least one of the one or more pre-determined spectrum evaluation rules includes a respective threshold, and for each of the at least one pre-determined spectrum evaluation rules, the respective threshold is one of: a maximum amount of the non-protocol-based interference metric; and a maximum amount of the protocol-based interference metric.

In some embodiments, obtaining the one or more spectrum quality measures for the frequency bandwidth of the communication band includes: obtaining a respective one or more spectrum quality measures for each of the one or more portions of the frequency bandwidth of the communication band. Further, evaluating the one or more spectrum quality measures against the one or more pre-determined spectrum evaluation rules includes: evaluating, for each of the one or more portions of the frequency bandwidth of the communication band, the respective one or more spectrum quality measures against the one or more pre-determined spectrum evaluation rules.

In some embodiments, the one or more channels define a quantity of channels; and the method further includes: obtaining, for at least one of the one or more channels, one or more respective channel configuration measures, all the one or more channel configuration measures defining a set of channel configuration measures; evaluating the set of channel configuration measures against one or more pre-determined configuration evaluation rules; and, based on the evaluating the set of channel configuration measures against the one or more pre-determined configuration evaluation rules: determining the quantity of channels, and initiating partitioning of the frequency bandwidth among the quantity of channels.

In some embodiments, obtaining the one or more respective channel configuration measures for the at least one of the one or more channels, evaluating the set of channel configuration measures against the one or more pre-determined configuration evaluation rules, determining the quantity of channels and initiating partitioning of the frequency bandwidth among the quantity of channels are performed repeatedly for responsiveness to changing communication conditions and channel configurations.

In some embodiments, the set of channel configuration measures includes at least one of: a number of connected devices communicating using the communication band; a number of contending unconnected devices communicating or attempting to communicate using the communication band; a respective value of a utilization metric for at least one of the one or more channels, the utilization metric indicative of a proportion of time that said at least one of the one or more channels is in use; and a respective value of a transmission quality metric for at least one of the one or more channels, the transmission quality metric indicative of observed or expected quality of transmissions made using the at least one of the one or more channels.

In some embodiments, the set of channel configuration measures includes: a number of connected devices communicating using the communication band; and a number of contending unconnected devices communicating or attempting to communicate using the communication band.

In some embodiments, at least one of the one or more pre-determined configuration evaluation rules includes a respective threshold, and for each of the at least one pre-determined configuration evaluation rules, the respective threshold is one of: a maximum number of connected devices communicating using the communication band; a maximum number of contending unconnected devices communicating or attempting to communicate using the communication band; a maximum value of the utilization metric; and a maximum value of the transmission quality metric, where the transmission quality metric is a decreasing function of said observed or expected quality of transmissions.

In some embodiments, at least one of the one or more pre-determined configuration evaluation rules includes a respective threshold and, for each of the at least one pre-determined configuration evaluation rules, the respective threshold includes at least one of: a sum of a maximum number of connected devices communicating using the communication band and a maximum number of unconnected devices communicating or attempting to communicate using the communication band; and an average of the maximum number of connected devices and the maximum number of unconnected devices.

In some embodiments, evaluating the set of channel configuration measures against the one or more pre-determined configuration evaluation rules includes evaluating a combination of channel configuration measures of the set of channel configuration measures against a combination of pre-determined configuration evaluation rules of the one or more pre-determined configuration evaluation rules.

In some embodiments, based on the evaluating the set of channel configuration measures against the one or more pre-determined configuration evaluation rules: determining the quantity of channels and initiating partitioning of the bandwidth among the quantity of channels includes: when one of the set of channel configuration measures or a combination of channel configuration measures of the set of channel configuration measures exceeds the threshold of one of the one or more pre-determined configuration evaluation rules, initiating dividing at least one of the one or more channels into a plurality of narrower channels.

According to another aspect there is provided an apparatus comprising a processor and a transceiver and configured to manage a communication band. The communication band is configured to have one or more channels each being either active or inactive. The communication band has associated thereto a frequency bandwidth including the one or more channels. The apparatus is operative to obtain one or more spectrum quality measures for the frequency bandwidth of the communication band. The apparatus is operative to evaluate the one or more spectrum quality measures against one or more pre-determined spectrum evaluation rules. The apparatus is operative, based on the evaluating the one or more spectrum quality measures against the one or more pre-determined spectrum evaluation rules, for one or more portions of the frequency bandwidth, to perform at least one of: initiating collective activation of each inactive channel of the one or more channels included in the one or more portions of the frequency bandwidth, and initiating collective deactivation of each active channel of the one or more channels included in the one or more portions of the frequency bandwidth.

The apparatus can further be configured to operate according to aspects and embodiments of the method as already described above.

These and other aspects of the invention will become apparent to those of ordinary skill in the art upon review of the following description of certain embodiments of the invention in conjunction with the accompanying drawings.

### BRIEF DESCRIPTION OF THE DRAWINGS

Further features and advantages of the present invention will become apparent from the following detailed description, taken in combination with the appended drawings, in which;

FIG. 1 illustrates an initialization and a first set of decision variables to configure the bandwidth of a network channel, according to an embodiment.

FIG. 2 illustrates operations to determine a number of network channels and their available bandwidth, according to an embodiment.

FIG. 3 illustrates the use of a second set of decision variables to enable and disable channels of the network, according to an embodiment.

FIG. 4 illustrates operations to determine whether to enable or disable channels of a network, according to an embodiment.

FIG. 5 illustrates the use of a third set of decision variables to configure the available spectrum that may be used by a network channel, according to an embodiment.

FIG. 6 illustrates operations to shut down or reactivate channels of a spectrum, according to an embodiment.

FIG. 7 illustrates a block diagram of an electronic device that may be used to implement any of the methods as described herein, according to an embodiment.

FIG. 8 illustrates a block diagram of an electronic device that may be used to implement any of the methods as described herein, according to an embodiment.

It will be noted that throughout the appended drawings, like features are identified by like reference numerals.

### DESCRIPTION OF THE INVENTION

Embodiments of the present invention provide methods, apparatus and systems to manage bandwidth in a network that may use in-band multi-channel configurations. In-band multi-channel capabilities can offer multiple (e.g. two, three or more) concurrent channels in a frequency band. The network may be a wireless network implementing the IEEE 802.11 family of protocols which may also be referred to as WiFi protocols, a WiFi network, etc. Configuration of a communications band may be done using some or all of the methods described herein based on measurements of network conditions. Embodiments allow for the configuring or dividing (or at least initiating of such configuring or dividing) the available communications spectrum into one or more channels of a predetermined bandwidth, the enabling and disabling of individual channels, and/or the activating and/or deactivating of spectrum (e.g. by activating and/or deactivating the usage of channels utilizing such spectrum, or initiating such activation and/or deactivation).

According to embodiments, wireless spectrum is managed, e.g. by an IEEE 802.11 access point (AP), in one or more of a variety of ways. In some embodiments, the management involves partitioning or initiating partitioning of a communication band or larger channel into multiple channels, or, conversely, merging multiple channels into a single channel, or a combination thereof. In some embodiments, the management involves enabling or, conversely, disabling a defined channel. In some embodiments, the management involves enabling, or conversely, disabling, a portion of wireless spectrum encompassing multiple channels, which can include enabling or disabling all of the encompassed channels. Each management operation can be performed based on respective information indicative of the wireless environment. As the information is updated due to periodic or continuous monitoring, the management operations can also be updated. The different management operations can be performed individually or in combination.

Embodiments of the present invention can be performed in association with wireless spectrum slicing. A portion of frequency can be partitioned into a configurable number of channels where those channels are defined in accordance with spectrum slicing. Multiple channels can be individually enabled or disabled, and/or channels in certain portions of frequency bandwidth can be collectively enabled or disabled, where those channels are defined in accordance with spectrum slicing. According to such spectrum slicing, one or more frequency bands can be divided into multiple channels. This allows more radios to operate in a given area. Spectrum slicing can operate at the PHY layer. Packet scheduling can then potentially operate using multiple channels, each of which is available to send packets. That is, in various embodiments, once channels are defined and enabled, a device such as an AP or device connected to the AP can use one, two or more of the defined and activated channels for communication, provided those channels are allocated for use in communication by the AP and/or appropriate device. Different channels or sets of channels can be allocated for use in communicating with different devices.

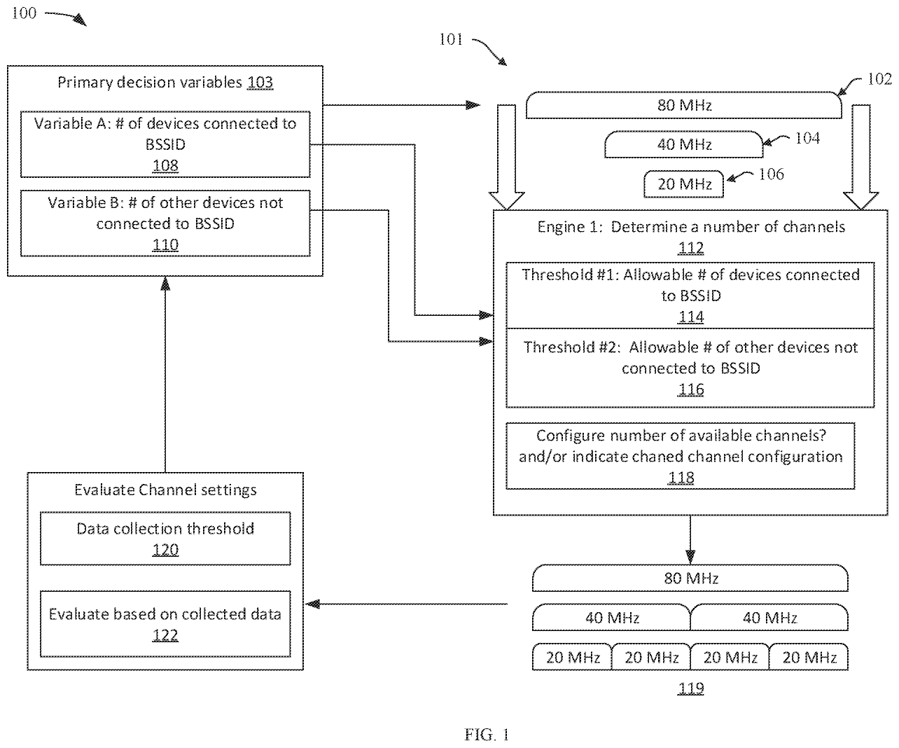

With reference to FIG. 1, a communications band 101 may have an available bandwidth, such as a frequency bandwidth, that depends on factors such as the communications protocols being implemented, the devices using the network, and other network conditions such as sources of noise and interference. In the example shown, the full channel 102 may have an available bandwidth of 80 MHz. However, using different protocols and devices, a smaller or larger bandwidth, such as, but not limited to, 40 MHz or 320 MHz may be available for the full available channel 102. The full channel 102 may be divided into smaller portions such as by dividing the channel 102 into two smaller half channels 104, which in this example would each be approximately 40 MHz wide. Furthermore, one or both of the half channels 104 may be further subdivided into two quarter channels 106, each of which would have a bandwidth of approximately 20 MHz. Although most examples described herein use 80 MHz of spectrum in specific communication bands, the general approach as described herein may be applicable to any frequency or spectrum width. For example, a full channel 102 having a bandwidth of 320 MHz would result, upon division into halves, in two half channels 104 of approximately 160 MHz each, and four quarter channels 106 of approximately 80 MHz each. As well, these 80 MHz quarter channels could be further divided into multiple smaller channels of 40 MHz, 20 MHz, etc. In embodiments, channels of different bandwidth, e.g. a division of a channel into multiple smaller channels, at least two of which have unequal size, may also be used. For example, a communications band with a total possible bandwidth of 80 MHz could be divided into three channels, including a 40 MHz half channel 104 and two 20 MHz quarter channels. Further, a communications band could be divided into a different number of channels, not necessarily 1, 2, 4, 8, 16 but in some embodiments may be divided into 3, 6, or any other number of channels of various bandwidths.

In embodiments, a communications band may be split into two channels, some or all of which, in turn may be further divided. This process may continue until a smallest (narrowest in terms of bandwidth) allowable channel is obtained. Furthermore and by a converse process, two channels may be combined to form one larger channel, and this process may be repeated until the widest channel width allowable/possible is obtained. Thus, once channels are defined via division of one or more channels, these channels may be combined to form the original channel or a channel being a portion of the original channel, or another channel comprising portions of two or more original channels. When a channel is divided into multiple channels, these channels can be termed “narrower channels” and the precursor can be termed a “wider channel”; similarly when multiple channels are merged into a larger channel, the multiple channels can be termed “narrower channels” and the resultant can be termed a “wider channel.” The process of separating a wider channel into multiple narrower channels can correspond with the partitioning process as described elsewhere herein. Narrower channels can also be referred to as sub-channels, with the understanding that the term “sub-channel” is not necessarily intended to have any other special technical meaning.

The process of splitting a communications band or a channel, or merging channels, can be described as partitioning a given bandwidth among channels. The given bandwidth can be, for example, an ISM band or a UNII band. The partitioning operation involves determining a number (quantity) of channels to operate in the band, as well as the bandwidths and (non-overlapping) frequency ranges of those channels. The partitioning decision can be, for example, that a single 80 MHz or 320 MHz channel are to be defined and used for communication with an AP, or that multiple 20 MHz or 40 MHz channels are to be defined and used, etc.

In various embodiments, each communications band or channel, whether a full channel 102, a half channel 104, a quarter channel 106, a third channel, etc. may be activated to become active or deactivated to become inactive. An activate channel is configured to carry traffic and may be actively used as such, whereas an inactive channel is configured to carry no traffic. That is, channels can be evaluated, for example individually, and activated or deactivated based on the evaluation. When a channel is deactivated, devices communicating via that channel may be triggered to use another channel. Channels subject to activation/deactivation may be defined via a partitioning as described above, or in another manner.

In various embodiments, the wireless spectrum (the frequencies used during communication operation) used by a channel may also be activated or deactivated. If a portion of the available spectrum is to be deactivated, then all channels using that portion of the spectrum may be deactivated. If a portion of the available spectrum is to be activated or reactivated, then channels may be configured within that portion of the spectrum. The channels may be channels which were previously defined within that portion of spectrum, or the channels can be defined following activation of the portion of spectrum. Thus, groups of one or more channels occupying a specified portion of wireless spectrum (e.g. a range of communication frequencies) can be activated or deactivated together. Portions of spectrum may include, for example the 2.4 GHz ISM band, or a portion of a 5 GHz UNII band. Spectrum subject to activation/deactivation may include channels defined via a partitioning as described above, or in another manner. Channels within active spectrum may be individually activated or deactivated as described above. If spectrum is deactivated, the channels therein become inactive. In some embodiments, if spectrum is reactivated, any prior activation/deactivation status of channels therein may be retained, or alternatively such status (if present) may be cleared and the channels may all be activated.

The invention will now be described with reference to specific examples. It will be understood that the following examples are intended to describe embodiments of the invention and are not intended to limit the invention in any way.

Initially, for purposes of discussion, the communications band may be configured as a single channel as wide as possible given the networking protocols being run. For a standard WiFi network, this may be a single 80 MHz band configured for 80 MHz wide channel operations. As well, the WiFi network may be identified and accessed using a BSSID associated with the network.

FIG. 1 illustrates how a channel in a communications band may be initialized and how a first set of values, in other words primary decision variables 103, may be measured to configure the bandwidth of the channels within the communications band by dividing or combining channels resulting in a desired number of channels and bandwidth of those channels. The first set of decision variables may be referred to as primary decision variables as they may be examined first when configuring or determining the channels of the communications band. Network equipment, such as a WiFi access point may monitor primary decision variables 103, which may further be referred to as channel configuration measures and may include variables related to the number of devices (e.g., client devices) that are using channel 102, 104, or 106. The primary decision variables 103 may include one or both of variable A 108 and variable B 110. The primary decision variables may include variable C and/or variable D, as described elsewhere herein. There may be one, two or more primary decision variables.

Variable A 108 may be a count of the number of clients or devices connected to the AP's network as indicated by the BSSID of the network. Devices undergo a particular process to connect to a network hosted by an AP. The AP, based on this process, can keep track of and thus count devices that are connected and/or registered to its network.

Variable B 110 may be the number of devices contending for the channel that are not trying to connect to the available BSSID, i.e., a number of contending unconnected devices. These may be devices that are wirelessly transmitting at frequencies of the channel using WiFi or another protocol, thus concurrently attempting to use (contending for) the channel.

One or more of the primary decision variable can be determined using beaconing data. In some embodiments, variables A and B, or similar decision variables, can be determined as follows. It is assumed that the relevant devices are WiFi or similar devices that periodically transmit an identifier such as a MAC address, for example as parts of packets used for various purposes. Furthermore, a device such as an access point will maintain a list of devices connected to the BSSID of the network (e.g. which the access point is hosting). By monitoring transmissions in the wireless environment (on some or all of the presently defined channels) one can determine the identifiers of devices which are communicating on the channel. These identifiers can be checked against the list of devices connected to the BSSID to determine devices which are both communicating and connected to the BSSID. The variable A can then be a count of such devices. The identifiers can also be checked against the list of devices connected to the BSSID to determine devices which are communicating but not connected to the BSSID. These may be devices which are “beaconing” (e.g. advertising their presence as an access point). The variable B can then be a count of such devices. The above can be performed by an AP configured via software, for example. Beacon messages may be data transmissions used by a device attempting to communicate with another device on a channel, e.g. to elicit a response from the other device.

Furthermore, because each WiFi device is required to have a unique MAC address to communicate, the MAC addresses of devices can be obtained by ‘sniffing’ the Ethernet packets which are contending for the channel. The count of devices (unique transceivers) which are trying to use a given physical channel can be determined based on their requests to ‘talk’ on that channel (e.g. in the form of beacon messages). The determination of whether or not each such device is connected to a specific channel which is being monitored can be based on the connection information stored in a spectrum slicing devices database or other list of devices. The spectrum slicing device database can track a list of devices operating in a portion of spectrum that is subject to slicing or partitioning, according to the present invention, into one or multiple channels.

In embodiments, other similar variables related to the number and type of devices may also be used. The primary decision variables 103 may be periodically updated. Activity on the wireless channel for example indicative of Variables A and B can be monitored continuously, periodically, or according to a schedule, and these variables can be updated accordingly.

In some embodiments, a primary decision variable may be indicative of a percentage or degree to which a channel is being utilized. In some embodiments, a primary decision variable may be indicative of a degree to which packets are retransmitted on a channel or set of channels. A primary decision variable may be indicative of an amount of congestion on a channel. A primary decision variable may be indicative of whether or not communication traffic on a channel has reached a level at which communications are degraded to a predetermined acceptable degree, e.g. as specified by a configurable or non-configurable threshold. Secondary decision variables (to be described below) may also have the above-described characteristics of primary decision variables.

Once data for the primary decision variables has been collected, this data may be provided to and received by an initial decision engine, that is labelled “Engine 1” 112 in FIG. 1. The engine is configured to determine how to best configure the number and bandwidth of the channels (potentially of different bandwidths) of the communications band, based at least in part on the primary decision variable information. In some embodiments, in order to evaluate the primary decision variables 103, a threshold is defined for each variable or for a combination of variables. This provides for a set of first thresholds, each of the first thresholds (e.g. threshold #1 114 and threshold #2 116) being associated with one of the primary decision variables.

In an embodiment, variable A 108 may be compared to threshold #1 114 which may indicate a maximum allowable (tolerable) number of devices that may connect to the network indicated by the BSSID (i.e., a maximum number of connected devices). Similarly, variable B 110 may be compared to threshold #2 116 which may indicate a maximum allowable (tolerable) number of other devices that may be contending for the channel that are not connected to the network indicated by the BSSID (i.e., a maximum number of contending unconnected devices). Engine 1 112 will then produce an output 118 indicative of whether or not to change the configuration of the number of channels available. Additionally or alternatively the output 118 may indicate the change (if any) to the configuration of the number of channels available. The output of Engine 1 may be based at least in part on comparisons of variables A and B to the thresholds #1 and #2. The terms “allowable” and “tolerable” may be used interchangeably. Maximum allowable or tolerable values can be set by an authority such as a human user/administrator or supervisory program.

Engine 1 112 may determine whether or not to change the current configuration of available channels. This may involve changing the number of available channels and their frequency/bandwidth allocations. If it is determined to change the current configuration, Engine 1 112 may determine the new configuration of available channels. Engine 1 112 may then produce the output 118 indicative of the new configuration of available channels. This indication may include the number of channels, their frequency/bandwidth allocations, and the like.

More generally, a predetermined evaluation rule (potentially but not necessarily involving thresholds) may be defined which maps collective values of primary decision variables to channel decisions. For example, when variable A is within a first range and variable B is within a second range, a first channel decision can be made. As another example, when a predetermined function (e.g. weighted or unweighted sum) of variables A and B is within a second range, the first channel decision can be made. Different ranges can be defined leading to different channel decisions.

The evaluation rule may involve logical conditions (e.g. whether a decision variable or function thereof falls below or above a threshold, or within a range). The evaluation rule may involve numerical operations or functions (e.g. summing, averaging or otherwise operating on decision variables to obtain another numerical value). The evaluation rule generally receives as input the decision variables and produces as output a relevant decision, in this case a partitioning of channels indicative of a quantity of channels and their respective non-overlapping bandwidths. The pre-determined evaluation rules for the primary decision variables 103 may be referred to as pre-determined configuration evaluation rules.

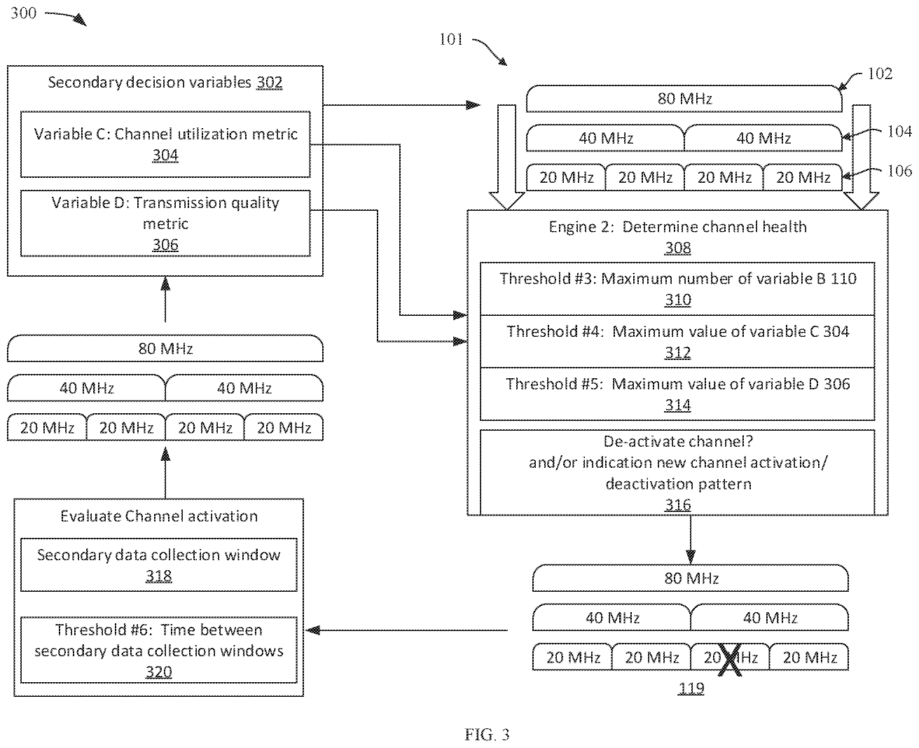

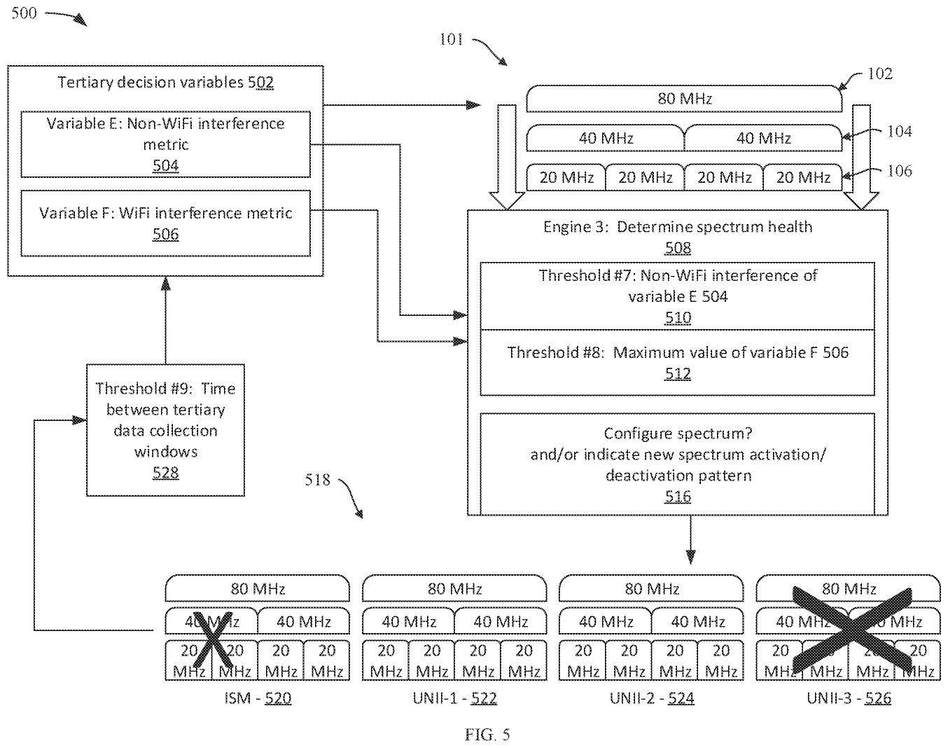

Similar evaluation rules, which may be referred to as pre-determined activation evaluation rules, may be implemented to evaluate secondary decision variables in order to determine whether to enable or disable an individual channel (or a combination of channels), as described below for example with respect to FIG. 3. Similar evaluation rules, which may be referred to as pre-determined spectrum evaluation rules, may be implemented to evaluate tertiary decision variables in order to determine whether to enable or disable portions of spectrum (encompassing one or more channels), or combinations of multiple portions of spectrum, as described below for example with respect to FIG. 5.

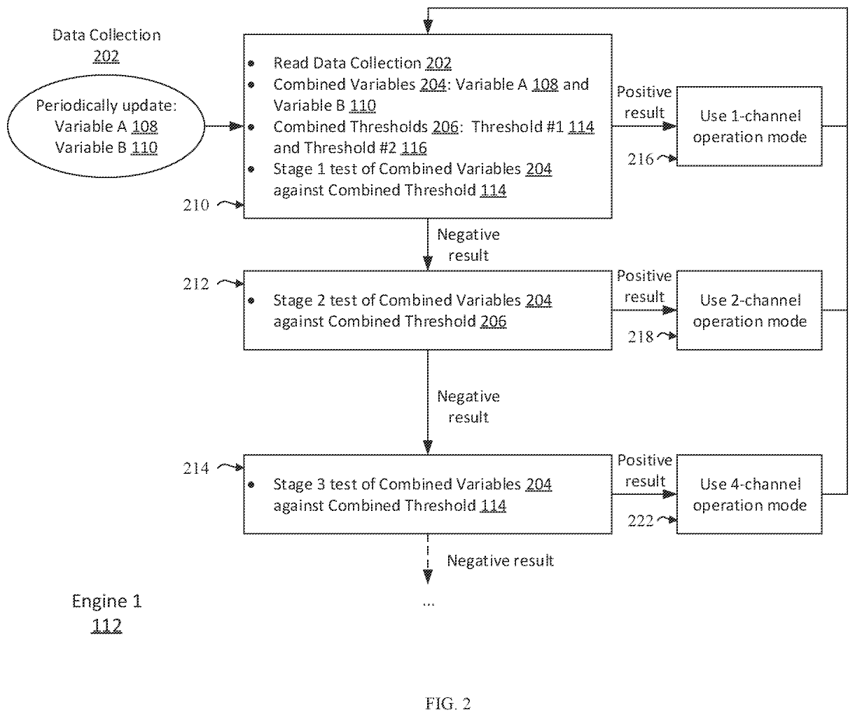

As illustrated, the possible channel configurations 119 may include combinations of channels (potentially of different bandwidths) such as an 80 MHz channel 102, one or two 40 MHz channels 104, and up to four 20 MHz channels 106. The possible channel configurations may include other sizes of channels. In general, the possible channel configurations may include one or more channels occupying (contiguously or non-contiguously) some or all of an available bandwidth, such as (for example) the bandwidth of an initial 320 MHz, 80 MHz, 40 MHz or 20 MHz channel. In an embodiment, the communications band may be configured as a single 80 MHz channel, two 40 MHz channels, four 20 MHz channels, eight 10 MHz channels, etc. It is also possible that dissimilar channels may also be configured such as one 40 MHz channel and four 10 MHz channels or another mix of sizes of channels. FIG. 2 provides further details on a particular embodiment of engine 1 112.

Determining (configuring) a number (quantity) of channels, as well as bandwidth of those channels can involve determining how to allocate an overall channel bandwidth to define one, two or more channels, according to a partitioning. The determination can involve determining whether to subdivide an existing channel to define multiple new channels, or whether to merge multiple existing (or newly defined) channels to define a new channel, or a combination thereof. Determining the number of channels is linked to determining the channels' bandwidth for example because the bandwidth of the existing channel is (e.g. equally) divided to define the bandwidths of multiple new channels which do not overlap in frequency.

Determining the number of channels involves determining the number of channels into which a predetermined bandwidth is to be subdivided. Determining the bandwidths of the channels includes determining an N-way partition of this predetermined bandwidth, where N is the determined number of channels. For example, if the predetermined bandwidth is B (e.g. 80 MHz) and the determined number of channels is N, then (assuming all channels are to have equal bandwidth), the bandwidth of each channel is determined as B/N, giving an N-way equal partition. As another example, the determination may be to divide bandwidth B into three channels, one channel having bandwidth B/2 and two channels having bandwidth B/4, giving a three-way unequal partition. More generally, the determination may be to divide bandwidth B into N non-overlapping channels each channel n having a bandwidth Bₙ where B₁+B₂+ . . . +Bₙ=B.

Primary decision variables 103 may be evaluated periodically based on additional data collection, based on an evaluation of collected data 122, or at regular time intervals. In an embodiment, the time between data collection periods or windows may be defined in a data collection threshold 120. In some embodiments, a detected change in a primary decision variable may trigger a re-evaluation by Engine 1.

For example, according to a period or schedule defined according to the data collection threshold 120, information indicative of the values for the primary decision variables 103 (e.g. variable A 108 and variable B 110) may be obtained. This information (i.e. the collected data) may then be evaluated 122 in order to update the primary decision variables themselves. The evaluation 122 may comprise the updating of primary decision variables. Once updated, the primary decision variables may be provided to Engine 1 and the above-described process may be repeated. The evaluation 122 may comprise determining whether or not the primary decision variables have changed. If they have changed, engine 1 may be triggered to operate again based on the primary decision variables. Otherwise, operation of engine 1 may be held off until a later time.

Primary decision variables may pertain to a single channel as it currently exists. That is, a single channel may be used to support a BSSID of an AP, and the primary decision variables may pertain to that BSSID and supporting channel. If there are multiple channels defined, each channel may support a different BSSID and each channel may thus be associated with its own set of primary decision variables. Each channel may have its own BSSID, and thus the primary decision variables may be applied to that BSSID and associated channel, for the purpose of determining whether or not that channel should be further subdivided, left alone, or become a candidate for being combined to create a wider channel.

FIG. 2 provides operations that may be implemented by Engine 1 112 when configuring or determining the channels of the communications band, according to an example embodiment. In step 202, data collection occurs and causes variable A 108 and variable B 110 to be periodically updated. In step 210, the up-to-date primary decision variables 103 from step 202 are received. A combined variable 204 may be produced from variable A and variable B using suitable techniques such as adding the values (with or without weightings), averaging the values, etc. As an example, the values of these two decision variables are added together. The two values may also be combined over a period of time, which may be a time window, or a time sliding window. The period of time may be configurable. The combined variable 204 is compared to a combined threshold 206, which may be generated based on the thresholds associated with variable A 108 and variable B 110, that is threshold #1 114 and threshold #2 116. The thresholds may be combined in the same way as the decision variables. In the present example, the thresholds #1 and #2 are added together to obtain the combined threshold 206. In a stage 1 test, the combined variable 204 is compared to the combined threshold 206. As an example, the stage 1 test can determine whether Variable A 108 plus Variable B 110 is equal to or less than threshold #1 114 plus threshold #2 116. In a positive result 216, i.e. when the combined variable 204 is equal to or less than the combined threshold, a single-channel operation mode is implemented. If the channel configuration already corresponds to the single-channel operation mode, it is not changed. For example, if the channel configuration was a single (80 MHz) channel, it will continue in that configuration in a single-channel operation mode with the widest channel width available. If another channel operation mode (e.g. two or four channel mode) is currently in use, channels may be combined to result in the single-channel operation mode. If the stage 1 test produces a negative result, i.e. when the combined variable 204 is greater than the combined threshold, then the operations proceed to step 212.

Step 212 may include a further, stage 2 test of the combined variables 204 against the combined thresholds 206. For example, step 212 may test whether Variable A 108 plus Variable B 110 is greater than: threshold #1 114 plus threshold #2 116, but less than or equal to two times the sum of: threshold #1 114 plus threshold #2 116. If the stage 2 test produces a positive result 218, i.e. when the combined variable 204 is equal to or less than twice the combined threshold, a two-channel operation mode is implemented. For example, if a single-channel (or four-channel) operation mode is currently in use, the communications band may be reconfigured to begin two channel operation with the widest channel width available. In some embodiments, if the stage 2 test produces a negative result (i.e. when the combined variable 204 is greater than twice the combined threshold) and the communications band is already configured for two channel operation, it may continue in a two channel operation mode with the widest channel width available. In other words, a negative result for the stage 2 test may result in the channel operation mode being unchanged. Upon a negative result in the stage 2 test, the stage 3 test of step 214 may be initiated. Additionally or alternatively, if the two-channel operation mode is currently in use, and the stage 2 test produces a positive result, the two-channel operation mode may be maintained according to operation 218.

Step 214 may include a further, stage 3 test of the combined variables 204 against the combined thresholds 206. For example, step 214 may test whether Variable A 108 plus Variable B 110 is greater than two times the sum of: threshold #1 114 plus threshold #2 116, but less than or equal to four times the sum of: threshold #1 114 plus threshold #2 116. If the test produces a positive result 222, i.e. when the combined variable 204 is equal to or less than four times the combined threshold, a four-channel operation mode may be implemented. For example, if an operation mode different from the four-channel operation mode is currently in use, the communications band may be reconfigured to begin four channel operation with the widest channel width available. In some embodiments, if the test produces a negative result (i.e. when the combined variable 204 is greater than four times the combined threshold) and the communications band is already configured for four channel operation, it may continue in the four channel operation mode with the widest channel width available. In other words, a negative result for the stage 3 test may result in the channel operation mode being unchanged. Additionally or alternatively, if the four-channel operation mode is currently in use, and the stage 3 test produces a positive result, the four-channel operation mode may be maintained according to operation 222. In various embodiments, in response to a negative result of the stage 3 test, one or more further similar tests may be performed which may result in an operation mode using more than four channels, provided that such number of channels is feasible. After an n-channel operation mode is implemented according to step 216, 218 or 222, the process may repeat with updated primary decision variables.

It should be understood that other operations using the primary decision variables could be used to determine the channel configuration within the communications band. Further, although described with a combination of threshold determinations being confirmed prior to a decision on the configuration of the channels within a communications band, it should be understood that some embodiments may employ a different combination of these threshold determinations to determine the configuration of the channels. These threshold determinations are designed to determine how congested the communications band is and what the ideal division of channels within the communications band would be to maximize quality of service. In some embodiments in which a plurality of different types of data (ex. video, internet data) are being transmitted over the communications band, a plurality of primary decision variables may be used in which devices are categorized by the type of data being requested and respective thresholds are implemented across types of data being transmitted.

In some embodiments, the number of devices streaming video, or the number of voice over internet protocol (VoIP) devices, or the number of devices with a particular other traffic pattern, can be determined. For example, the number of devices communicating time-sensitive data or bandwidth intensive data can be determined. Time sensitive data may be real-time data associated with live video, games, voice or video communications, live sensor data, etc. Bandwidth intensive data can be associated with video or games. Such counts of devices can be used as primary or secondary decision variables. Because traffic patterns from particular devices may vary, the number of devices of a particular type (or the number of traffic patterns of a particular type) may be considered in addition to or alternatively to the overall number of connected devices and/or the overall number of unconnected contending devices (e.g. primary decision variables). Such a consideration may be applicable in application based routing. For example, there may be set limits on the number of devices carrying traffic of a certain type (e.g. time sensitive or bandwidth intensive data), or the number of streams of that type. The numbers determined above can be used, as primary or secondary decision variables, to address such limits. For example, when the number of devices, on a channel, with a particular traffic pattern or type exceeds a threshold, an action can be taken such as disabling the channel, separating the channel into multiple channels, etc.

In some embodiments, partitioning of a channel, as described elsewhere herein, can be performed to generate multiple channels each being dedicated to a type of data being communicated, or a predetermined mixture of such types. The data type can be time-sensitive data or bandwidth intensive data, or another type of data with a particular traffic pattern. For example, a first channel can be allocated for carrying control data, and a second channel can be allocated for carrying real-time (e.g. video or voice) data. Further, a certain channel can be dedicated to carrying video data.

In embodiments, the operations implemented by Engine 1 112 may be repeated until a maximum channel density (as measured by the bandwidth and/or number of channels in use, such as channel 106) available is reached. The operations of FIG. 2 may also be performed in reverse to decrease channel density (fewer channels) when appropriate.

For example, according to FIG. 2, one of a plurality of partitioning modes (1-channel, 2-channel or 4-channel operation modes in this case) are selected based on the numerical range into which a sum of the primary decision variables falls. The edges of the ranges are defined by the combined thresholds. When the primary decision variables change, the sum of the primary decision variables may fall within a different range. In this event, the partitioning mode can also change. When the partitioning mode changes, the partitioning of spectrum may change so that a different number of channels (corresponding to the new partitioning/operation mode) are present. Therefore, the number of channels can be changed, along with their bandwidths.

For example, when the combined variable 204 (e.g. sum of variables A and B) falls below the combined threshold 206, a one-channel operation mode can be initiated (by merging channels into a single channel) or continued (if already in that mode). When the combined variable 204 (e.g. sum of variables A and B) is above the combined threshold 206 but below twice the combined threshold, a two-channel operation mode can be initiated (by splitting a channel into two channels or merging multiple channels into two channels) or continued (if already in that mode). When the combined variable 204 (e.g. sum of variables A and B) is above twice the combined threshold 206 but below four times the combined threshold, a four-channel operation mode can be initiated (by creating four channels from one or more predecessor channels via splitting, merging, or a combination thereof) or continued (if already in that mode). It is noted that the above thresholds are examples only and can be varied.

Although the above considers that the combined variables and combined thresholds are scalar values, they may alternatively be vector values. For example the combined variable may be a vector of variable A and variable B, and the combined threshold may be a vector of threshold #1 and threshold #2. A stage 1, 2 or 3 test may test whether or not one or both vector components of the combined variable are greater than one or both vector components of the combined threshold. Similarly, when evaluating secondary or tertiary decision variables, scalar or vector testing or comparisons can be performed.

FIG. 3 illustrates the use of a second set of values, in other words secondary decision variables 302 to activate and de-activate channels of the communications band, such as channels 102, 104, and 106. This allows the system to determine the health of any or all channels and determine if they should be used. The second set of decision variables may be referred to as secondary decision variables as they may be examined second after the primary decision variables described with respect to FIG. 1 and FIG. 2 when configuring or determining configuration of the communications channel. Network equipment, such as a WiFi access point may monitor secondary decision variables 302, which may further be referred to as channel activation measures and may include variables related to channel utilization and channel quality. The secondary decision variables 302 may include one or more of variable B, variable C 304 and variable D 306. The secondary decision variables may include variable A.

Variable C 304 may be a channel utilization metric, for example a measurement of the airtime utilization of the channel. Variable C may indicate, for example, the proportion of time that a channel is in use. Variable C may be determined by monitoring activity on the channel using a wireless receiver or wireless power monitoring device. In some embodiments, for purposes of determining the channel utilization metric, a channel may be deemed “in use” when another device is using the channel, whether or not that other device is communicatively coupled to the access point and performing communications according to the BSSID of the access point. The channel utilization metric may thus be indicative of a proportion of time that a channel is in use.

Variable D 306 may be a transmission quality metric, for example a packet retransmission rate, a packet retransmission percentage, a bit error rate, etc. Variable D may be determined from monitored communication activities at an AP, or as reported by one or more devices, for example. In embodiments, other similar variables related to the channel utilization and the channel or transmission quality may also be used. A transmission quality metric may generally indicate the observed or expected quality of transmissions, in view of collisions, interference, noise, or other aspects of the radio environment. The transmission quality metric may be based for example on expected number of retransmissions, required modulation and coding scheme, etc. Quality may correspond to error rate and/or the rate of requirement for retransmissions. That is, the quality may correspond at least in part to an error rate or a retransmission requirement rate. The transmission quality metric may be a decreasing function of error rate or retransmission requirement rate.

The secondary decision variables 302 may be periodically updated.

As mentioned above, one or more of the secondary decision variables may be the same as one or more of the above-described primary decision variables. For example, the secondary decision variables may be indicative of a level of congestion on one or more channels, or indicative of whether or not communication traffic on a channel has reached a level at which communications are degraded to a predetermined acceptable degree, e.g. as specified by a configurable or non-configurable threshold. Accordingly, an indication of congestion can be used to determine whether a channel should be enabled or disabled. For example, channels which are highly congested (e.g. due to activities by other devices not associated with the AP or devices connected to the AP) may be disabled. Furthermore, one or more of the primary decision variables may be the same as one or more of the above-described secondary decision variables.

The secondary decision variables may be collected and evaluated on a per-channel basis. For example, if a single 80 MHz channel is in use, the secondary decision variables may be collected and evaluated as they pertain to that 80 MHz channel. If one or more 40 MHz channels are in use, the secondary decision variables may be collected and evaluated as they pertain to each of those 40 MHz channels. If one or more 20 MHz channels are in use, the secondary decision variables may be collected and evaluated as they pertain to each of those 20 MHz channels.

Some or all of the primary and/or secondary decision variables may be obtained and applied on a per-channel and/or per-BSSID basis. This is in contrast to tertiary decision variables which may be applied on a per-portion-of-spectrum basis. Each channel under consideration may be defined and associated with a BSSID, for example as advertised by an AP. Some or all of the primary and/or secondary decision variables may be based on environment in which WiFi packets are transmitted and potentially collide, which is related to the BSSID and channel.

In some embodiments, the secondary decision variables may be collected and evaluated for channels that are not currently in use. These may include channels that are defined but currently inactive. An example of this is the 20 MHz channel of FIG. 3 which is currently inactive (marked with an X). These channels not currently in use may include channels that contain or are contained within other channels that are currently in use or are inactive. For example, if a 20 MHz channel is in use, the 40 MHz channel and 80 MHz channel having overlapping bandwidth with that 20 MHz channel may not be in use. If a 40 MHz channel is in use, the 20 MHz channels having bandwidths within that 40 MHz channel may not be in use.

In some embodiments, in order to collect decision variable information for channels that are not currently in use, one or more devices may transmit and/or receive test packets using this channel, and monitor the relevant decision variable information based on the test packets, such as channel utilization and transmission quality.

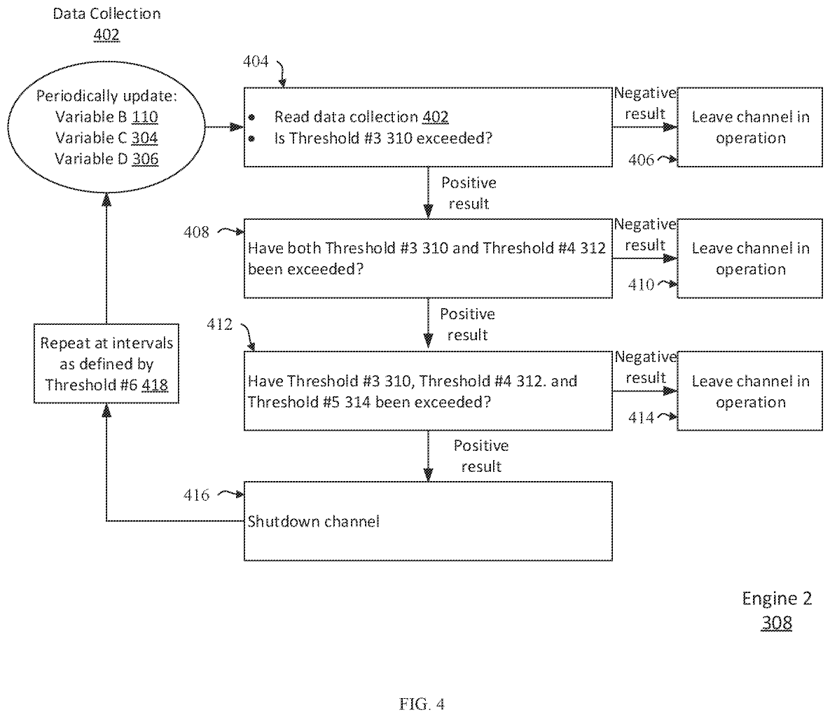

Once data for the secondary decision variables has been collected, they may be received by a second decision engine, that is labelled “Engine 2” 308 in FIG. 3, to determine how to best configure channels by activating them or deactivating them, or initiating such activation or deactivation, possibly to be performed by another device. In order to evaluate the secondary decision variables 302, a threshold may be defined for each variable (a set of second thresholds). In an embodiment, variable B 110 may be compared to threshold #3 310 which may be a maximum allowable number of other devices that may be contending for the channel that are not connected to the network indicated by the BSSID. Variable B 110, when used by Engine 2 308, may be regarded as being a secondary decision variable. As an example, threshold #3 310 may be “greater than 12”, though other numbers for threshold #3 may be used. Similarly, variable C 304 may be compared to threshold #4 312 which may be a maximum percentage of airtime utilization of a channel. As an example, threshold #4 312 may be “greater than 50%”, though other percentages of airtime utilization may be used. Variable D 306 may be compared to threshold #5 314 which may be a maximum percentage of a packet retransmission rate of a channel. As an example, threshold #5 314 may be “greater than 75%”, though other percentages of packet retransmission rate may be used. Engine 2 308 will then produce an output indicating whether a channel 102, 104, or 106 may be activated or deactivated. Secondary decision variables 302 may be collected for any or all configured channels or the communication band as a whole and the method of FIG. 3 and FIG. 4 may be performed for any or all configured channels. Further, only one secondary decision variable or a plurality of secondary decision variables may be used in some embodiments to determine whether to activate or deactivate a channel. FIG. 4 provides further details on a particular embodiment of engine 2 308.

The engine 2 will then determine 316 whether a channel being evaluated should be active or inactive. This may involve for example de-activating an active channel. The determination can be made separately for each channel under evaluation. The determination can be made based on the comparisons of decision variables to thresholds as described above. For example, if decision variables B, C and D are all less than their respective thresholds 3, 4, and 5, the channel under evaluation can remain (or become) active. Otherwise, the channel can be made (or kept) inactive. The new channel activation/deactivation pattern corresponding to which channels are activated and/or which are deactivated, or changes (if any) to the current activation/deactivation pattern can also be indicated.

The Engine 2 308 may evaluate each of a plurality of channels separately, and make determinations to activate or de-activate each channel independently. In other embodiments or cases, the Engine 2 308 may make determinations to activate or de-activate channels interdependently. For example, the engine 2 may be configured to avoid taking actions that result in all channels being deactivated, by forcing at least one channel (e.g. the best available channel) to be active at all times. Furthermore, in some embodiments, when a first channel has a high utilization and/or low transmission quality, instead of deactivating the channel immediately, one or more other channels may be activated and traffic of connected devices may be redirected to those newly activated channels in an attempt to improve conditions on the first channel. This process may correspond to client steering, which may be performed in association with other embodiments or aspects of the present invention.

De-activated channels can be activated in a similar manner to deactivation, based for example on decision variable information obtained from test packets or other channel monitoring. In some embodiments, de-activated channels may be provisionally activated from time to time in order to obtain decision variable information due to the usage of those channels.

Secondary decision variables 302 may be evaluated periodically based on additional data collection, based on an evaluation of collected data, or at regular time intervals. In an embodiment, the time between data collection periods or windows may be defined in a data collection threshold #6 320. Data indicative of the secondary decision variables 302 is collected periodically during secondary data collection window 318. Each time after such data is collected in a window 318 the secondary decision engine can operate and determine whether to activate or deactivate one or more channels, and initiate such activations/deactivations. The threshold #6 320 can be fixed or variable. By repeatedly determining secondary decision variables and running the secondary decision engine, channel activation patterns can be tested, evaluated and adapted over time and in response to variable conditions.

Although FIG. 3 illustrates the use of thresholds, other approaches to evaluating and responding to secondary decision variables can be used. Generally, one, two or more secondary decision variables may be processed according to one or more predetermined numerical and/or logical functions and the output(s) may be used to determine whether a channel should be active (e.g. activated if not active) or non-active (e.g. de-activated if active). There are a variety of ways in which one, two or more secondary decision variables can be mapped to such activation/non-activation decisions. A predetermined evaluation rule may thus operate on secondary decision variables to produce an output indicating whether a channel is to be active or inactive. Such a predetermined evaluation rule may be referred to as a pre-determined activation evaluation rule. The evaluation rule may involve logical and/or numerical operations performed on the decision variables.

FIG. 4 provides operations that may be implemented by Engine 2 308 when configuring a communications channel, according to an embodiment. In step 402, data collection occurs and causes variable B 110 (which may be received from data collection step 202), variable C 304 and variable D 306 for all channels and/or bands of interest, to be periodically updated. Data collection step 402 may push updated data to step 404, or step 404 may periodically poll data collection step 402 for updated secondary decision variables. In step 404, the up-to-date secondary decision variables from step 402 are received or made available. Variable B 110 is compared to threshold #3 310 and it is determined if the number of clients indicated by variable B 110 exceeds the maximum allowable (tolerable) value, as indicated by threshold #3 310. If a negative result is obtained, i.e., the maximum number of clients is not exceeded, in step 406, the channel may be left in operation if already active. If a positive result is obtained in step 404, i.e., threshold #3 310 is exceeded, then the operations proceed to step 408. In step 408, an evaluation of whether both variable B 110 exceeds threshold #3 310 and variable C 304 exceeds threshold #4 312 can be made. (The evaluation for variable B may be inherited from step 404.) If both thresholds are not exceeded, a negative result 410 is obtained and the channel may be left in operation if already active. If both thresholds are exceeded then a positive result is obtained, and the operations proceed to step 412. In step 412, an evaluation of whether variable B 110 exceeds threshold #3 310, variable C 304 exceeds threshold #4 312, and variable D 306 exceeds threshold #5 314. (The evaluations for variables B and C may be inherited from step 410.) If all three thresholds are not exceeded, a negative result 414 is obtained and the channel may be left in operation if already active. If all three thresholds are exceeded then a positive result is obtained and the operations proceed to step 416 and the channel is shut down (i.e., deactivated).

In various embodiments, the thresholds #3 and #4 are the same in all steps; in other embodiments, at least one of the thresholds #3 and #4 differ in at least two of the steps 404, 408, 412. Notably, according to FIG. 4, each channel is evaluated independently of other channels, based on three decision variables. It is noted that all of the evaluation steps 404, 408 and 412 can be merged into a single integrated step in some embodiments, using a logical/numerical expression involving all of the secondary decision variables and their corresponding thresholds. Other, more complex evaluation functions may also be used.

The variables may be updated at repeating intervals as may be defined by threshold #6 418. Variable B 110, variable C 304, and variable D 306 may be collected over a period of time, over a window, or over a sliding window, etc. The operations of Engine 2 308 may be repeated at regular time intervals as set by threshold #6 (for example 2 hours), and may be applied in reverse to activate channels that have been deactivated. For example, if for a deactivated channel, one or more of decision variables A, B and C are less than their respective threshold #1, #2 or #3 (according to decision variable values obtained from test packets or other sources), then the channel may be re-activated. The conditions for re-activation may or may not be the exact inverse of the conditions for de-activation. In some embodiments, a channel may have to be active in order to collect data. Although described with a combination of threshold determinations being confirmed prior to a decision on the activation or deactivation of a channel, it should be understood that some embodiments may employ a different combination of these threshold determinations to determine whether to maintain a channel active or deactivate the channel. These threshold determinations are designed to determine if a channel is overly congested to provide sufficient quality of service.

FIG. 5 illustrates the use of a third set of values, in other words tertiary decision variables 502 to shut down or activate channels, such as channels 102, 104, and 106 in a particular spectrum of specific bands of the communications band. This involves the system determining the health of a spectrum band and whether or not it should be used. The third set of decision variables may be referred to as tertiary decision variables as they may, in some embodiments, be examined third after the primary decision variables, described with respect to FIG. 1 and FIG. 2, and after the secondary decision variable, described with respect to FIG. 3 and FIG. 4, when configuring or determining the channels of the communications band. Network equipment, such as a WiFi access point with spectrum analyzer functionality or that have access to spectrum data may monitor tertiary decision variables 502, which may further be referred to as spectrum quality measures and may include variables related to non-WiFi interference, and inter-channel (WiFi) interference. The tertiary decision variables 502 may include one or both of variable E 504 and variable F 506.

Variable E 504 may be a measurement of a non-protocol-based interference metric, such as an amount of interference from non-WiFi interferers, noise, or a combination thereof. The amount of interference from non-WiFi interferers can be indicative of activity (wireless transmissions or emissions) in the wireless environment which causes or potentially causes interference, where such activity is performed or generated according to a process (e.g. a protocol) other than a WiFi protocol. Notably, such interference may be due to communications or other non-communication processes (e.g. microwaves, radar, industrial, scientific or medical processes) which generate interference in that they emit radiofrequency energy at frequencies falling within the relevant communication channels. Accordingly, variable E may measure an amount of a non-protocol-based interference metric indicative of wireless activity causing interference and generated according to a process other than a communication protocol used by the access point.

Variable F 506 may be a measurement of a protocol-based interference metric, such as an amount of interference from inter-channel interferers or noise. The tertiary decision variables 502 may be periodically updated. The amount of interference inter-channel interferers may be interference WiFi interferers. Such interference can be indicative of activity (wireless transmissions or emissions) in the wireless environment which causes or potentially causes interference, where such activity is performed according to a WiFi protocol (or other protocol of the access point). Accordingly, variable F may measure an amount of a protocol-based interference metric indicative of wireless activity causing interference and generated according to the communication protocol used by the access point.

Tertiary decision variables may be determined by monitoring radio environment conditions, for example using a wireless spectrum analyzer or similar device. Such monitoring does not necessarily require demodulating or decoding of signals, but rather can be performed by measuring raw RF signals. The tertiary decision variables may measure what may be considered to be noise, such as other transmissions that interfere with a desired transmission. If another transmission is creating enough ‘noise’ to substantially interfere with the desired transmission, then it is considered that the part of the band containing this other transmission becomes unusable by the desired transmission and should be avoided. Accordingly, a tertiary decision variable may be a metric that measures or reflects the level of undesired transmissions (or noise) within an observed frequency band or portion thereof. This measurement may then be used as a metric to activate or deactivate operation in that frequency band or portion thereof, based on whether or not the level of noise has reached a level at which communications are degraded to a predetermined acceptable degree, e.g. as specified by a configurable or non-configurable threshold.

Indications of non-protocol based interference and indications of protocol-based interference can be determined using same or similar techniques or using different techniques. For example, indications of non-protocol based interference can be determined by measuring wireless signal strength or RF power, treated as noise, using a spectrum analyzer, possibly along with statistical techniques or other techniques which do not necessarily take into account behaviours according to any specific protocol. Indications of protocol-based interference can be determined by similar methods, possibly where the statistical techniques are refined based on behaviours according to the relevant protocol (e.g. WiFi). Additionally or alternatively, indications of protocol-based interference can be based on measures of collisions, beacons, certain types of WiFi packets, etc. and statistical measurements based on same. Tertiary decision variables can be determined based at least in part on the presence or absence of noise signatures, which are predetermined types or patterns (in frequency and/or time) of noise which indicate a certain type of interference activity, for example due to activities of certain devices communicating according to certain protocols.

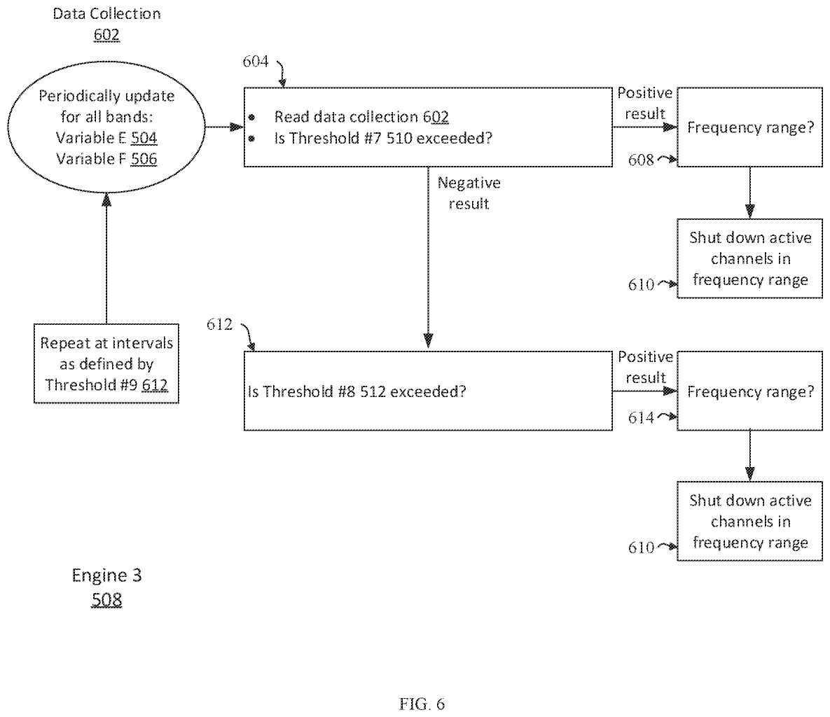

Once data for the tertiary decision variables 502 has been collected, this data may be received by a tertiary decision engine, that is labelled “Engine 3” 508 in FIG. 5, to determine how to best utilize spectrum by configuring channels by activating them or deactivating them as required. In order to evaluate the tertiary decision variables 502, a threshold may be defined for each variable (a set of third thresholds). In an embodiment, variable E 504 may be compared to threshold #7 510, which may be a maximum amount of the non-protocol-based interference metric such as a maximum allowable persistent existence of Non-WiFi interference. As an example, threshold #7 510 may be “visible greater than 25% of the time.” That is, if threshold #7 is exceeded 25% of the time, then the threshold can be considered to be exceeded in general and the corresponding action taken. Similarly, variable F 506 may be compared to threshold #8 512, which may be a maximum amount of the protocol-based interference metric such as a maximum amount of persistent existence of Inter-Channel interferers. As an example, threshold #8 512 may be “visible greater than 25% of the time.” Engine 3 508 will then produce an output indicating whether spectrum should be used or not and a decision may be made to deactivate channels 102, 104, or 106 that are operating in spectrum that should not be used. Tertiary decision variables 502 may be collected for any range of spectrum that is used by channels or that may be used by channels. FIG. 6 provides further details on a particular embodiment of engine 3 508.

The engine 3 will then make a determination 516 of whether a portion of spectrum being evaluated should be active or inactive (meaning the channels contained therein should be active or inactive, for example). This may involve for example de-activating an active portion of spectrum or activating an inactive portion of spectrum, by de-activating or activating its constituent channels. The determination can be made separately for each portion of spectrum under evaluation. The determination can be made based on the comparisons of decision variables to thresholds as described above. For example, if decision variables E and F are all less than their respective thresholds 7 and 8, the spectrum under evaluation can remain (or become) active. Otherwise, the spectrum can be made (or kept) inactive. The new spectrum activation/deactivation pattern corresponding to which portions of spectrum are activated and/or which are deactivated, or changes (if any) to the current spectrum activation/deactivation pattern can also be indicated. Activating/deactivating a portion of spectrum can involve collectively activating/deactivating all channels defined for that portion of spectrum.

Similarly to the case with engines 1 and 2, engine 3 can evaluate tertiary decision variables in a variety of ways. The evaluation can involve determining whether a logical combination of threshold tests are passed or not. Each threshold test can indicate whether a decision variable is less than or greater than a given threshold. The evaluation, according to an evaluation rule (i.e., a pre-determined spectrum evaluation rule), can involve other logical and/or numerical functions involving one or more decision variables, where the outcome of the evaluation is an indication of whether one or more portions of spectrum should be active or inactive.

As illustrated, due to outputs of Engine 3, the lower 40 MHz of the ISM band and the UNII-3 band are inactive, while the upper 40 MHz of the ISM band, the UNII-1 band and the UNII-2 band are active. Thus, for example, channels allocated to these portions of spectrum according to Engine 1 and/or channels activated in these portions of spectrum according to Engine 2 can be active and used.

Tertiary decision variables 502 may be evaluated periodically based on additional data collection, based on an evaluation of collected data, or at regular time intervals. In an embodiment, the time between data collection periods or windows may be defined by threshold #9 528 which in embodiments may be from 20-180 minutes, though shorter or longer time periods could be used. Data indicative of the tertiary decision variables 502 is collected periodically during tertiary data collection window. Each time after such data is collected in a window the tertiary decision engine can operate and determine whether to activate or deactivate one or more portions of spectrum, and initiate such activations/deactivations. The threshold #9 528 can be fixed or variable. By repeatedly determining tertiary decision variables and running the tertiary decision engine, spectrum activation patterns can be tested, evaluated and adapted over time and in response to variable conditions.

Tertiary decision variables may be collected and evaluated separately for each of a plurality of spectra. For example, tertiary decision variables can be collected and evaluated separately for one or more of: the ISM band 520, the UNII-1 band 522, the UNII-2 band 524 and the UNII-3 band 526. Additionally or alternatively, tertiary decision variables can be collected and evaluated separately for one or more subsets of such bands, for example the lower 40 MHz of the ISM band and the upper 40 MHz of the ISM band, etc.

In some embodiments tertiary decision variables for multiple bands can, at least in part, be collected together, for example via a wideband spectrum analyzer scanning operation. In various embodiments, evaluation by engine 3 of different sets of tertiary decision variables for different bands can be performed independently or else interdependently. For example, decisions to shut down a certain portion of spectrum may depend on the number of other portions of spectrum which are operational.

FIG. 6 illustrates operations to shut down or reactivate channels of a spectrum that may be used by Engine 3 508 when configuring spectrum of a communications band. In step 602, data collection occurs and causes variable E 504 and variable F 506 for all bands of interest, to be periodically updated. In embodiments, data collection 602 may be performed continuously at 10 minute intervals using a rolling average of the collected data. Data collection step 602 may push updated data to step 604, or step 604 may periodically poll data collection step 602 for updated tertiary decision variables. In step 604, the up-to-date tertiary decision variables from step 602 are received or made available. Variable E 504 is compared to threshold #7 510 and it is determined if the amount of persistent existence of Non-WiFi interference, indicated by variable E 504 exceeds the maximum allowable value, as indicated by threshold #7 510. If a positive result is obtained, i.e., the amount of interference exceeds the threshold, in step 608, the frequency range of the spectrum is identified, and in step 610, active channels operating in that spectrum are shut down. If a negative result is obtained in step 604, i.e., threshold #7 510 is not exceeded, then the operations proceed to step 612. In step 612, an evaluation of whether variable F 506 exceeds threshold #8 512 is made. If a positive result is obtained, i.e., the amount of interference exceeds the threshold, in step 614, the frequency range of the spectrum is identified, and in step 610, active channels operating in that spectrum are shut down. For identifying frequency ranges in steps 608 and 614, before the channel(s) is/are potentially shut down, the frequency range which is the range spanned by the interference may be identified and the channels falling within this frequency range may be identified. Then, those particular channels may be shut down. The comparisons can be made separately for each of a plurality of bands/spectral ranges and/or portions thereof. Thus, a portion of spectrum is shut down (the channels thereof deactivated) if either threshold #7 or threshold #8 is exceeded by its associated tertiary decision variable. Other logical/numerical tests involving the decision variables can also be implemented to arrive at a determination of whether or not to shut down a band, spectrum or portion thereof.

The variables may be updated at repeating intervals as may be defined by threshold #9 612. Variable E 504 and variable F 506 may be collected over a period of time, over a window, or over a sliding window, etc. The operations implemented by Engine 3 508 may be repeated at regular time intervals as set by threshold #9 (for example every hour), and may be applied in reverse to activate channels and their spectrum that has been previously shut down. For example, if, for a band or spectrum portion, variables E and F are both below their respective thresholds 7 and 8 on an iteration of Engine 3, the band or spectrum portion can be activated. Activation can involve removing restrictions previously imposed by Engine 3, if any, on the operation of channels defined for that band or spectrum portion. However, in some embodiments, if Engine 2 has deactivated such a channel, the deactivation may remain in place. Other precedence rules for activations/deactivations between engines are also possible.

As described herein, primary decision variables (also referred to as channel configuration measures) are used in Engine 1 as shown in FIGS. 1-2. The primary decision variables can include a number of connected devices and/or a number of contending unconnected devices. Similarly, secondary decision variables (also referred to as channel activation measures) are used in Engine 2 as shown in FIGS. 3-4. The secondary decision variables can include the number of contending unconnected devices, a utilization metric value, and/or a transmission quality metric value. However, it is considered that the primary decision variables can additionally or alternatively include one or more of the utilization metric value, and/or the transmission quality metric value. Furthermore, it is considered that the secondary decision variables can additionally or alternatively include the number of connected devices. More generally, the primary decision variables, secondary decision variables, or both, can include one or more measures of congestion of the wireless access medium or channels thereof.

Time windows over which decision variables are obtained and/or evaluated (e.g. times between primary, secondary and/or tertiary data collection windows) can be adjustable. These time windows can be defined for example according to the data collection threshold 120, the threshold #6 418 and the threshold #9 612. For example, during certain times of day or under certain conditions, the time windows can be shortened or lengthened. For example, because wireless networks have a significant number of environmental variables (for example an empty stadium vs a full one, or a rush hour train station vs weekend tourist traffic), the flexibility in configuring the timeframe with which the variables are combined may be important. For example, one might use a shorter time window during weekday daytimes, and longer windows during other times. Durations of time windows may be adjusted based on information such as congestion data.

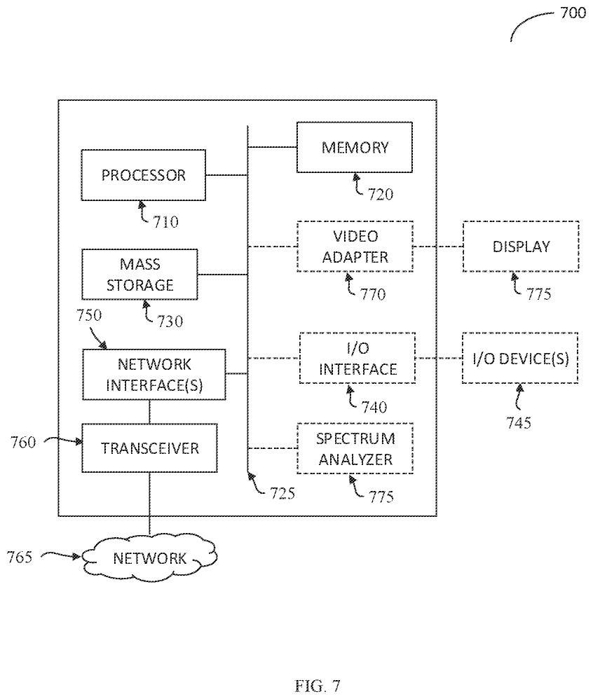

FIG. 7 is a block diagram of an electronic device 700 illustrated within a computing and communications environment that may be used for implementing the devices and methods disclosed herein. In some embodiments, the electronic device 700 may be an element of communications such as a router, or access point compatible with WiFi standards. In other embodiments, the electronic device 700 may be a device that connects to a WiFi network such as a mobile phone, smart phone, consumer electronics device, Internet of Things (IoT) device, or other such wireless device. Specific devices may utilize all of the components shown or only a subset of the components, and levels of integration may vary from device to device. Furthermore, a device may contain multiple instances of a component, such as multiple processors, memories, transmitters, receivers, etc. The electronic device 700 typically includes a processor 710, such as a Central Processing Unit (CPU), and may further include specialized processors such as a Graphics Processing Unit (GPU) or other such processor, a memory 720, one or more network interfaces 750 and a bus 725 to connect the components of electronic device 700. Electronic device 700 may optionally also include components such as a mass storage device 730, a video adapter 770, and an I/O interface 740 (shown in dashed lines). In some embodiments, the electronic device 700 may comprise a spectrum analyzer 775 as described with reference to FIG. 5 and FIG. 6 or may be coupled to a spectrum analyzer and operable to receive information from the spectrum analyzer.

The memory 720 may comprise any type of non-transitory system memory, readable by the processor 710, such as static random-access memory (SRAM), dynamic random access memory (DRAM), synchronous DRAM (SDRAM), read-only memory (ROM), or a combination thereof. In specific embodiments, the memory 720 may include more than one type of memory, such as ROM for use at boot-up, and DRAM for program and data storage for use while executing programs. The bus 725 may be one or more of any type of several bus architectures including a memory bus or memory controller, a peripheral bus, or a video bus.

The electronic device 700 may also include one or more network interfaces 750, which may include at least one of a wired network interface and a wireless network interface. Each network interface 750 may be associated with a transceiver 760 to interface with each network 765. As illustrated in FIG. 7, network interface 750 may include a wired network interface to connect to a network 765, which may be a WiFi compatible network. When electronic device 700 is a WiFi compatible base station, access point, router, etc., both wired and wireless network interfaces may be included. The network interfaces 110 allow the electronic device 700 to communicate with remote entities such as those connected to network 765.

The mass storage 730 may comprise any type of non-transitory storage device configured to store data, programs, instructions, and other information and to make the data, programs, and other information accessible via the bus 725. The mass storage 730 may comprise, for example, one or more of a solid-state drive, hard disk drive, a magnetic disk drive, or an optical disk drive. In some embodiments, mass storage 730 may be remote to the electronic device 700 and accessible through use of a network interface such as interface 750. In the illustrated embodiment, mass storage 730 is distinct from memory 720 where it is included, and may generally perform storage tasks compatible with higher latency, but may generally provide lesser or no volatility. In some embodiments, mass storage 730 may be integrated with a memory 720 to form a heterogeneous memory.

The optional video adapter 770 and the I/O interface 740 (shown in dashed lines) provide interfaces to couple the electronic device 700 to external input and output devices. Examples of input and output devices include a display 775 coupled to the video adapter 770 and an I/O device 745 such as a touchscreen coupled to the I/O interface 740. Other devices may be coupled to the electronic device 700, and additional or fewer interfaces may be utilized. For example, a serial interface such as Universal Serial Bus (USB) (not shown) may be used to provide an interface for an external device. Those skilled in the art will appreciate that in embodiments in which electronic device 700 is providing WiFi access, I/O interface 745 and video adapter 770 may be virtualized and provided through network interface 750.

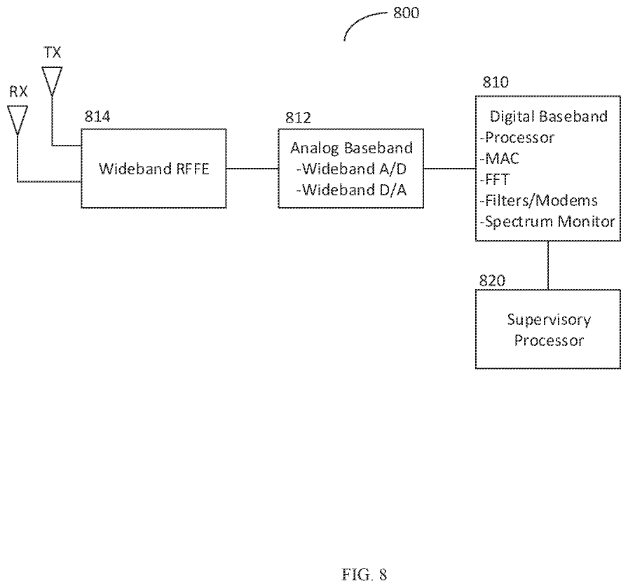

FIG. 8 illustrates another apparatus 800 provided according to embodiments of the present invention. The apparatus may be formed using one or a plurality of electronic chips, for example. The apparatus includes a digital baseband section 810 which may include components such as a computer processor, a medium access control (MAC) module, a spectrum monitor such as a spectrum analyzer, and digital signal processing components such as a fast Fourier transform (FFT) module, filters, modems, etc.

The digital baseband section 810 is configured to perform certain operations for preparing signals for wireless transmission and processing wirelessly received signals, as will be readily understood by a worker skilled in the art. The digital baseband section 810 is further configured to perform operations for monitoring or analyzing portions of spectrum and monitoring channels and the radio environment in order to obtain indications of the primary, secondary and/or tertiary decision variables. For example, the digital baseband section 810 may use the spectrum monitor/spectrum analyzer to obtain indications of tertiary decision variables, and may also provide indications of beacons, received packets, etc. which are indicative of primary and/or secondary decision variables. This information can be provided to a supervisory processor 820 which is integrated with or separate from the processor of the digital baseband section.

The supervisory processor 820 may be a computer processor executing instructions stored in memory, or other processing electronics utilizing hardware, software and/or firmware. The supervisory processor is configured to perform the methods as described herein, including receiving indications of primary, secondary and/or tertiary decision variables, operating engines #1, #2 and/or #3, or the like, and providing management outputs such as partitioning bandwidth into channels, enabling/disabling channels and/or enabling/disabling portions of spectrum. The supervisory processor can configure the digital baseband section 810 according to its management outputs, to cause transmission and reception operations using channels and/or portions of spectrum as defined by the supervisory processor.

The digital baseband section 810 interacts with an analog baseband section 812. The analog baseband section converts digital signals, from the digital baseband section and indicative of wireless transmissions, into corresponding analog signals. The analog baseband section further receives analog signals indicative of wireless receptions into corresponding digital signals which are provided to the digital baseband section. For this purpose the analog baseband section includes analog-to-digital converters and digital-to analog converters, which may be wideband in nature. Various received signals handled by the analog baseband section can be converted into and/or used to generate indications of the primary, secondary and/or tertiary decision variables.

The wideband radiofrequency front end (RFFF) 814 operates as an intermediary between the analog baseband section 812 and transmit and receive antennas. The RFFE 814 facilitates the wireless transmission and reception of signals as will be readily understood by a worker skilled in the art. The RFFE may be wideband in the sense that it can facilitate transmission and/or reception of signals over a range of bandwidths, such as the 2.4 GHz ISM band, one or more 5 GHz UNII bands, or a combination thereof. The components of the apparatus 800 may be configured to operate in accordance with an IEEE 802.11 (WiFi) protocol.

In some embodiments, in order to support spectrum slicing, two or more radio transceivers or components (e.g. modems) are utilized. For example, the digital baseband section can include one set of components dedicated to each channel in the spectrum slicing paradigm. Each such set of components can be separately configured, enabled or disabled, etc.

Actions associated with methods described herein can be implemented as coded instructions in a computer program product. In other words, the computer program product is a computer-readable medium upon which software code or instructions is recorded to execute the method when the computer program product is loaded into memory and executed on a processor of a computing device.

Further, each operation of the method may be executed on any real or virtual computing device, such as a personal computer, server, tablet, smartphone, electronic chip, set of electronic chips, or the like and pursuant to one or more, or a part of one or more, program elements, modules or objects generated from any programming language, such as C++, Java, or the like. Electronic chips may be computer chips having a processor executing computer program instructions, and/or firmware and/or electronic hardware implementing set or programmable logical and processing operations. In addition, each operation, or a file or object or the like implementing each said operation, may be executed by special purpose hardware or a circuit module designed for that purpose.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

1. A method for managing a communication band at an access point of a network, the communication band having a frequency bandwidth associated thereto and configured to have one or more channels, the one or more channels defining a quantity of channels, the method comprising:
obtaining, for at least one of the one or more channels, one or more respective channel configuration measures, all the one or more channel configuration measures defining a set of channel configuration measures;
evaluating the set of channel configuration measures against one or more pre-determined configuration evaluation rules; and,
based on the evaluating the set of channel configuration measures against the one or more pre-determined configuration evaluation rules:
determining the quantity of channels, and
initiating partitioning of the frequency bandwidth among the quantity of channels.

2. The method of claim 1 wherein obtaining, evaluating, determining and initiating partitioning are performed repeatedly for responsiveness to changing communication conditions and channel configurations.

3. The method of claim 1 wherein the set of channel configuration measures includes at least one of:
a number of connected devices communicating using the communication band,
a number of contending unconnected devices communicating or attempting to communicate using the communication band,
a respective value of a utilization metric for at least one of the one or more channels, the utilization metric indicative of a proportion of time that said at least one of the one or more channels is in use, and
a respective value of a transmission quality metric for at least one of the one or more channels, the transmission quality metric indicative of an observed or expected quality of transmissions made using the at least one of the one or more channels.

4. The method of claim 1 wherein the set of channel configuration measures includes:
a number of connected devices communicating using the communication band, and
a number of contending unconnected devices communicating or attempting to communicate using the communication band.

5. The method of claim 1 wherein at least one of the one or more pre-determined configuration evaluation rules includes a respective threshold, and, for each of the at least one pre-determined configuration evaluation rules, the respective threshold is or involves at least one of:
a maximum number of connected devices communicating using the communication band,
a maximum number of contending unconnected devices communicating or attempting to communicate using the communication band,
a maximum value of the utilization metric, and
a maximum value of the transmission quality metric, where the transmission quality metric is a decreasing function of said observed or expected quality of transmissions.

6. The method of claim 4 wherein at least one of the one or more pre-determined configuration evaluation rules includes a respective threshold and, for each of the at least one pre-determined configuration evaluation rules, the respective threshold includes at least one of:
a sum of a maximum number of connected devices communicating using the communication band and a maximum number of unconnected devices communicating or attempting to communicate using the communication band, and
an average of the maximum number of connected devices and the maximum number of unconnected devices.

7. The method of claim 1 wherein evaluating the set of channel configuration measures against the one or more pre-determined configuration evaluation rules includes:
evaluating a combination of channel configuration measures of the set of channel configuration measures against a combination of pre-determined configuration evaluation rules of the one or more pre-determined configuration evaluation rules.

8. The method of claim 1 wherein at least one of the one or more pre-determined configuration evaluation rules includes a respective threshold, and wherein, based on the evaluating the set of channel configuration measures against the one or more pre-determined configuration evaluation rules, determining the quantity of channels and initiating partitioning of the frequency bandwidth among the quantity of channels includes:
when one of the set of channel configuration measures or a combination of channel configuration measures of the set of channel configuration measures exceeds the threshold of one of the one or more pre-determined configuration evaluation rules, initiating dividing at least one of the one or more channels into a plurality of narrower channels.

9. The method of claim 1 wherein the communication band is configured to operate by a protocol including an IEEE 802.11 WiFi standard.

10. The method of claim 1 wherein:
each of the one or more channels is designated as either active or inactive; and
the method further comprises:
obtaining, for at least one of the one or more channels, one or more respective channel activation measures, all the channel activation measures defining a set of channel activation measures;
evaluating the set of channel activation measures against one or more pre-determined channel evaluation rules; and
based on the evaluating the set of channel activation measures against the one or more pre-determined channel evaluation rules, at least one of:
initiating activation of an inactive channel of the one or more channels, and
initiating deactivation of an active channel of the one or more channels.

11. The method of claim 10 wherein the set of channel activation measures includes at least one of:
a number of connected devices communicating using the communication band,
a number of contending unconnected devices communicating or attempting to communicate using the communication band,
a respective value of a utilization metric for at least one of the one or more channels, the utilization metric indicative of a proportion of time that said at least one of the one or more channels is in use, and
a respective value of a transmission quality metric for at least one of the one or more channels, the transmission quality metric indicative of an observed or expected quality of transmissions made using the at least one of the one or more channels.

12. The method of claim 10 wherein the set of channel activation measures includes one or both of:
a respective value of a utilization metric for at least one of the one or more channels, the utilization metric indicative of a proportion of time that said at least one of the one or more channels is in use, and
a respective value of a transmission quality metric for at least one of the one or more channels, the transmission quality metric indicative of an observed or expected quality of transmissions made using the at least one of the one or more channels.

13. The method of claim 10 wherein at least one of the one or more pre-determined channel evaluation rules includes a respective threshold, and for each of the at least one pre-determined channel evaluation rules, the respective threshold is one of:
a maximum number of connected devices communicating using the communication band,
a maximum number of contending unconnected devices communicating or attempting to communicate using the communication band,
a maximum value of the utilization metric, and
a maximum value of the transmission quality metric, where the transmission quality metric is a decreasing function of said observed or expected quality of transmissions.

14. The method of claim 10 wherein evaluating the set of channel activation measures against one or more pre-determined channel evaluation rules includes:
evaluating a combination of channel activation measures of the set of channel activation measures against a combination of pre-determined channel evaluation rules of the one or more pre-determined channel evaluation rules.

15. The method of claim 10 wherein the method includes, for each of the one or more channels:
obtaining one or more respective channel activation measures, and
evaluating the one or more respective channel activation measures against the one or more pre-determined channel evaluation rules.

16. An apparatus comprising a processor and a transceiver and configured to manage a communication band, the communication band having a frequency bandwidth associated thereto and configured to have one or more channels, the one or more channels defining a quantity of channels, the apparatus operative to:
obtain, for at least one of the one or more channels, one or more respective channel configuration measures, all the one or more channel configuration measures defining a set of channel configuration measures;
evaluate the set of channel configuration measures against one or more pre-determined configuration evaluation rules; and,
based on the evaluating the set of channel configuration measures against the one or more pre-determined configuration evaluation rules:
determine the quantity of channels, and
initiate partitioning of the frequency bandwidth among the quantity of channels.

17. The apparatus of claim 16, wherein obtaining, evaluating, determining and initiating partitioning are performed repeatedly for responsiveness to changing communication conditions and channel configurations.

18. The apparatus of claim 16, wherein the set of channel configuration measures includes at least one of:
a number of connected devices communicating using the communication band,
a number of contending unconnected devices communicating or attempting to communicate using the communication band,
a respective value of a utilization metric for at least one of the one or more channels, the utilization metric indicative of a proportion of time that said at least one of the one or more channels is in use, and
a respective value of a transmission quality metric for at least one of the one or more channels, the transmission quality metric indicative of an observed or expected quality of transmissions made using the at least one of the one or more channels.

19. The apparatus of claim 16, wherein at least one of the one or more pre-determined configuration evaluation rules includes a respective threshold, and, for each of the at least one pre-determined configuration evaluation rules, the respective threshold is or involves at least one of:
a maximum number of connected devices communicating using the communication band,
a maximum number of contending unconnected devices communicating or attempting to communicate using the communication band,
a maximum value of the utilization metric, and
a maximum value of the transmission quality metric, where the transmission quality metric is a decreasing function of said observed or expected quality of transmissions.

20. The apparatus of claim 16, wherein at least one of the one or more pre-determined configuration evaluation rules includes a respective threshold, and wherein, based on the evaluating the set of channel configuration measures against the one or more pre-determined configuration evaluation rules, determining the quantity of channels and initiating partitioning of the frequency bandwidth among the quantity of channels includes:
when one of the set of channel configuration measures or a combination of channel configuration measures of the set of channel configuration measures exceeds the threshold of one of the one or more pre-determined configuration evaluation rules, initiating dividing at least one of the one or more channels into a plurality of narrower channels.
